(19) United States
(12) Patent Application Publication
(10) Pub. No.: US 2026/0126468 A1
(43) Pub. Date: May 7, 2026

(54) METHOD FOR DETECTING SEMICONDUCTOR CARRIERS USING A NANOMETER-SCALE MICROWAVE PROBE INTEGRATED WITH AN ATOMIC FORCE MICROSCOPE

(71) Applicant: National Cheng Kung University, Tainan City (TW)

(72) Inventors: Yi-Chun Chen, Tainan City (TW); Si-An Wen, Tainan City (TW); Yi-De Liou, Tainan City (TW); Tien-Tzu Chin, Tainan City (TW)

(21) Appl. No.: 19/008,713

(22) Filed: Jan. 3, 2025

(30) Foreign Application Priority Data
Nov. 4, 2024 (TW) 113142181

(51) Int. Cl. G01Q 60/40; G01Q 60/34

(52) U.S. Cl. CPC G01Q 60/40; G01Q 60/34

(57) ABSTRACT

A method for detecting semiconductor carriers using a nanometer-scale microwave probe in conjunction with an atomic force microscope (AFM). The method optimizes the transmission of microwave signals within the AFM system by determining the optimal carrier frequency for high-frequency measurements. The method includes operating the AFM in tapping mode, emitting a microwave signal from the AFM probe, amplitude modulating the signal, and scanning the semiconductor sample to detect sideband signals. The detected sideband signals are analyzed to identify the optimal carrier frequency for subsequent measurements, such as Scanning Microwave Impedance Microscopy (sMIM) and Sideband Electrostatic Force Microscopy (Sideband-EFM). Additionally, the invention employs impedance matching techniques, including double-stub and multi-stub impedance matching, to enhance the efficiency of microwave signal transmission. This method generates detailed carrier distribution maps of the semiconductor sample, providing crucial insights into the electrical properties of the semiconductor material.

### FIELD OF THE DISCLOSURE

The present invention relates to methods for detecting semiconductor carriers using atomic force microscopy. More specifically, the invention pertains to techniques that utilize a nanometer-scale microwave probe to detect and analyze carrier concentration and distribution within semiconductor materials. The invention includes methods for optimizing the transmission of microwave signals within an atomic force microscope system, with an emphasis on identifying the optimal carrier frequency for subsequent high-frequency measurements.

### BACKGROUND OF THE INVENTION

Semiconductor devices are fundamental to modern electronics, and their performance heavily relies on the precise control and measurement of carrier concentration and distribution within semiconductor materials. Atomic force microscopes (AFMs) are widely used in the semiconductor industry for nanoscale imaging and characterization. However, traditional AFM techniques often lack the capability to directly measure electrical properties, such as carrier concentration, at the nanoscale.

To overcome this limitation, microwave-based techniques have been developed, including Scanning Microwave Impedance Microscopy (sMIM) and Electrostatic Force Microscopy (EFM). These techniques involve applying microwave signals to the AFM probe and measuring the interaction between the microwaves and the semiconductor sample material to assess its electrical characteristics. Specifically, Sideband Electrostatic Force Microscopy (Sideband-EFM) utilizes amplitude-modulated microwave signals to generate sidebands, which are then analyzed to extract detailed electrical properties of the semiconductor sample.

However, the effectiveness of these techniques is largely dependent on the efficient transmission of microwave signals within the AFM system, particularly through the cantilever. Impedance mismatches within the system can lead to significant signal loss, reducing the sensitivity and accuracy of measurements. Furthermore, implementing and maintaining waveguides for microwave signal transmission within the cantilever typically incurs high costs and operational complexity.

### SUMMARY OF THE INVENTION

The present invention provides a method for detecting semiconductor carriers using a nanometer-scale microwave probe integrated with an atomic force microscope (AFM). The core aspect of the invention lies in optimizing the transmission of microwave signals within the AFM system by determining the optimal carrier frequency, thereby enhancing the accuracy and efficiency of analyzing carrier concentration and distribution in semiconductor samples.

The invention comprises a method wherein the AFM operates in tapping mode near the resonance frequency of its cantilever. A microwave signal at a specified carrier frequency is emitted from a conductive AFM probe and is amplitude-modulated at a lower modulation frequency. As the AFM probe scans the semiconductor sample, sideband signals are generated and detected using a lock-in amplifier. These sideband signals are then analyzed to determine the optimal carrier frequency that facilitates efficient microwave signal transmission within the AFM system. This optimal carrier frequency is subsequently utilized for high-frequency measurements, such as Scanning Microwave Impedance Microscopy (sMIM) and Sideband Electrostatic Force Microscopy (Sideband-EFM).

To enhance the transmission efficiency of microwave signals into the semiconductor sample, the invention employs impedance matching techniques. Specifically, double-stub impedance matching is used to adjust the impedance between the microwave signal generator and the AFM probe, ensuring effective transmission of microwave energy through the cantilever. In addition to double-stub impedance matching, the invention may also utilize single-stub impedance matching or multi-stub impedance matching depending on the specific impedance matching scenarios.

The detected sideband signals are not only used to identify the optimal carrier frequency but also to generate detailed carrier distribution maps of the semiconductor sample. These maps provide critical information about the spatial distribution of carriers within the semiconductor material, which is essential for evaluating the electrical properties of the sample, identifying defects, and ensuring the quality of semiconductor devices.

In summary, the invention offers the following advantages:
1. Cost-Effectiveness: By determining the optimal carrier frequency that allows direct signal transmission through the AFM, the invention significantly reduces the costs and complexity associated with high-frequency AFM measurements, eliminating the need for complex waveguides.
2. Enhanced Measurement Accuracy: Utilizing double-stub impedance matching techniques ensures effective microwave signal transmission to the cantilever, reducing signal loss and maximizing measurement sensitivity.
3. Versatility: The method can be applied to various high-frequency measurement techniques, such as Scanning Microwave Impedance Microscopy and Sideband Electrostatic Force Microscopy, making it adaptable to a wide range of research and industrial applications.
4. Improved Sensitivity and Precision: By optimizing the carrier frequency and employing impedance matching, the system minimizes signal reflections and losses, resulting in high-quality data with reduced noise interference. This allows for more precise analysis of carrier concentration and distribution.

Therefore, the present invention provides a more efficient, cost-effective, and accurate method for detecting and analyzing semiconductor carriers, addressing the limitations of existing AFM measurement technologies.

### BRIEF DESCRIPTION OF THE DRAWINGS

The objects, spirits, and advantages of the preferred embodiments of the present disclosure will be readily understood by the accompanying drawings and detailed descriptions, wherein:

FIG. 1 illustrates a flowchart of one embodiment of the method for detecting semiconductor carriers according to the present invention.

FIG. 2 illustrates a schematic diagram of one embodiment of the system for detecting semiconductor carriers according to the present invention.

FIG. 3 illustrates a flowchart of the double-stub impedance matching process set in this embodiment.

FIG. 4 illustrates a schematic diagram of performing double-stub impedance matching in this embodiment.

FIG. 5 illustrates a flowchart of the process for generating a carrier distribution map.

FIG. 6 illustrates the experimental results obtained at various carrier frequencies.

FIG. 7 displays carrier distribution maps of a WSe₂ sample with mixed stacking sequences.

FIG. 8 illustrates carrier distribution maps of standard concentration calibration samples for n-type and p-type semiconductors.

### DESCRIPTION OF THE PREFERRED EMBODIMENTS

The current methods utilizing an atomic force microscope (AFM) to detect and analyze carrier concentration and distribution in semiconductor materials have significant limitations. Traditional AFM techniques, such as Scanning Capacitance Microscopy and Electrostatic Force Microscopy (EFM), while effective in surface topography imaging, lack the sensitivity required for detailed electrical measurements at the nanoscale. Additionally, these methods typically require the semiconductor sample surface to have a thin oxide layer to function properly, making them less suitable for direct semiconductor analysis.

Furthermore, existing microwave-based AFM technologies, including Scanning Microwave Impedance Microscopy (sMIM) and Sideband Electrostatic Force Microscopy (Sideband-EFM), are highly dependent on the efficient transmission of microwave signals between the AFM probe and the cantilever. Impedance mismatches in the transmission path can lead to signal reflections and losses, thereby reducing the accuracy and sensitivity of measurements. Moreover, the implementation of complex waveguide systems within the cantilever to effectively transmit microwave signals is not only costly but also technically challenging.

The present invention addresses these challenges by providing a method and system for detecting semiconductor carriers using a nanometer-scale microwave probe integrated with an atomic force microscope. The invention achieves precise measurement of carrier concentration and distribution in semiconductor materials by determining the optimal carrier frequency to optimize the transmission of microwave signals within the AFM system.

The method includes operating the atomic force microscope in tapping mode near the cantilever's resonance frequency, emitting a microwave signal from the AFM probe, modulating the amplitude of the signal, and scanning the semiconductor sample. The resulting sideband signals are detected and analyzed to determine the optimal carrier frequency, which is subsequently used for measurements including Scanning Microwave Impedance Microscopy (sMIM) and Sideband Electrostatic Force Microscopy (Sideband-EFM).

To improve signal transmission efficiency, the invention employs impedance matching techniques, including double-stub impedance matching and single-stub impedance matching. These techniques allow for more effective impedance matching over a broader range of carrier frequencies. These techniques reduce signal loss and enhance the sensitivity of measurements. Additionally, the detected sideband signals can be used to generate detailed carrier distribution maps, providing important insights into the electrical properties of the semiconductor sample.

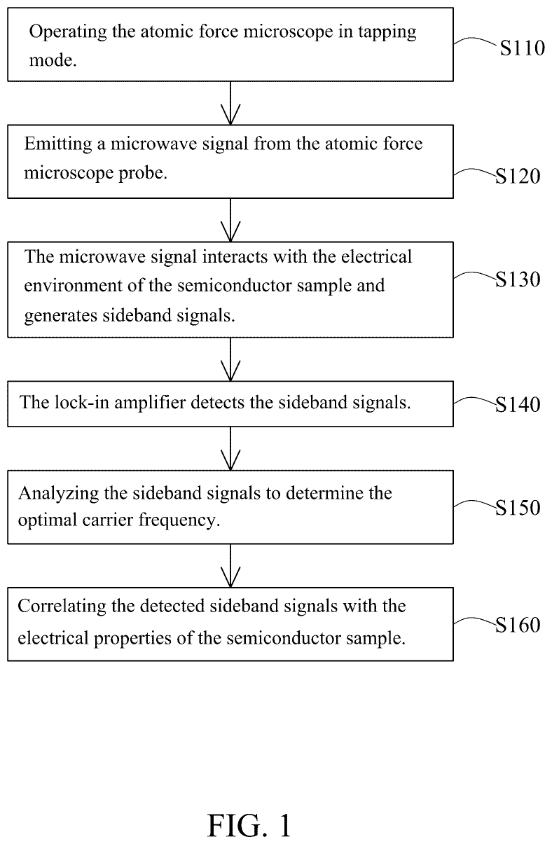

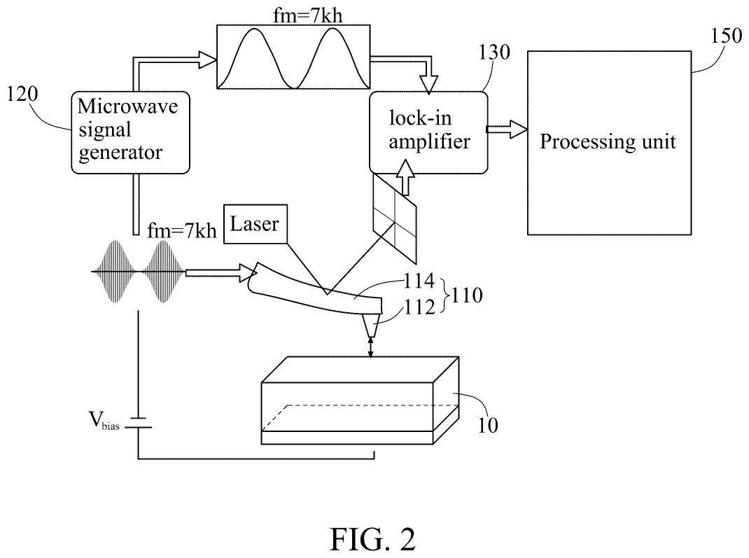

Referring to FIG. 1 and FIG. 2, FIG. 1 illustrates a flowchart of one embodiment of the method for detecting semiconductor carriers according to the present invention, and FIG. 2 illustrates a schematic diagram of one embodiment of the system for detecting semiconductor carriers according to the present invention.

Initially, as shown in step S110, the atomic force microscope 110 is operated in tapping mode. In this embodiment, the AFM probe 112 oscillates near the resonance frequency of the cantilever 114 of the atomic force microscope 110 and intermittently contacts the surface of the semiconductor sample 10. In this embodiment, the cantilever 114 of the AFM 110 typically operates at a resonance frequency of approximately 70 kHz. The selection of this tapping mode is because it reduces lateral forces on the surface of the semiconductor sample 10, thereby minimizing damage and improving the quality of the electrical and topographical data collected. In this embodiment, the semiconductor sample 10 is a doped semiconductor with a carrier concentration range of 10¹⁶ to 10²⁰ carriers per cubic centimeter.

When the AFM operates near the resonance frequency of cantilever 114, the cantilever's sensitivity to external forces reaches a maximum, allowing it to detect subtle interactions between AFM probe 112 and the surface of semiconductor sample 10 while minimizing noise during the measurement process. In this tapping mode, AFM probe 112 scans the surface of semiconductor sample 10, periodically contacting the surface of semiconductor sample 10 as probe 112 oscillates.

Next, referring to step S120, a microwave signal with a carrier frequency fc is emitted from AFM probe 112. This carrier frequency is typically in the range of 2 GHz to 7.7 GHz. The microwave signal is generated by the microwave signal generator 120 integrated into the AFM system 100.

The microwave signal is amplitude-modulated at a lower modulation frequency fm, typically in the range of 1 kHz to 10 kHz. Amplitude modulation is employed because it causes the intensity of the microwave signal to vary over time, generating sideband signals relative to the resonance frequency fd of the cantilever 114 at frequencies fd-fm and fd+fm.

It is noteworthy that, in this specification, the term “resonance frequency fd” refers to the frequency at which the cantilever 114 of the AFM system 100 oscillates when driven by probe 112. The resonance frequency fd is set near the natural resonance frequency of the cantilever, which is the frequency at which the cantilever vibrates with maximum amplitude. However, for the purposes of the present invention, the resonance frequency fd is not limited strictly to the natural resonance frequency but also includes frequencies within the half-power bandwidth of the resonance peak. The half-power bandwidth refers to the range of frequencies near the resonance peak where the amplitude decreases to 70.7% (1/√2) of the maximum value. Within this range, the AFM system 100 can still effectively drive probe 112 to oscillate, enabling the detection of sideband signals and high-sensitivity measurements. This definition allows for fine-tuning of the driving frequency to optimize signal detection while maintaining effective oscillation within the AFM system 100.

When AFM probe 112 scans semiconductor sample 10, the microwave signal emitted from probe 112 interacts with the electrical properties of semiconductor sample 10 (e.g., carrier concentration and distribution), affecting the reflection, absorption, or transmission of microwave energy.

As AFM probe 112 scans semiconductor sample 10, as shown in step S130, the modulated microwave signal interacts with the electrical environment of semiconductor sample 10, generating detectable sideband signals at frequencies fd-fm and fd+fm. These sideband signals contain critical information about the carrier concentration and electrical properties of semiconductor sample 10.

As AFM probe 112 continues to scan semiconductor sample 10, the detected sideband signals are recorded, providing a data set that correlates the interaction of microwave signals with the electrical properties of semiconductor sample 10 at different locations.

Additionally, as shown in step S140, the lock-in amplifier 130 in the AFM system 100 is used to detect these sideband signals. The lock-in amplifier 130 is tuned to the sideband frequencies, thereby filtering out noise and isolating the desired specific signals. This is important for ensuring the accuracy of measurements, as the sideband signals encode information about the electrical properties of semiconductor sample 10, including variations in carrier concentration and distribution.

Once the sideband signals are detected, the next step is to perform step S150, analyzing these sideband signals to determine the optimal carrier frequency fc. The optimal carrier frequency is the frequency that enables the most efficient transmission of microwave signals within the AFM system 100, minimizing signal loss and enhancing the amplitude of the sideband signals.

By comparing the strength and quality of sideband signals detected at different carrier frequencies, the AFM system 100 can identify the carrier frequency that produces the strongest sideband response. This carrier frequency is then used for further high-frequency measurements, such as Scanning Microwave Impedance Microscopy (sMIM) or Sideband Electrostatic Force Microscopy (Sideband-EFM), to conduct more detailed analysis of the semiconductor sample.

The analysis process also includes step S160, correlating the detected sideband signals with the electrical properties of the semiconductor sample, allowing AFM 110 to assess changes in carrier concentration and distribution. This information is important for characterizing semiconductor devices, as it provides in-depth insights into the material's electrical performance and can identify potential defects or inhomogeneities.

Furthermore, to effectively transmit the microwave signal from AFM probe 112 to semiconductor sample 10, impedance matching must be achieved between the microwave signal generator 120, AFM probe 112, and semiconductor sample 10. This is necessary to minimize signal reflections and losses, thereby preserving the AFM system 100's ability to accurately measure the carrier characteristics of semiconductor sample 10. To address this issue, the impedance matching technique employed in this embodiment is double-stub impedance matching. Double-stub impedance matching is a technique used for impedance matching in high-frequency transmission lines, particularly suitable for adjusting impedance in microwave systems. In this technique, two adjustable transmission line segments 142 are placed in the transmission path between the microwave signal generator 120 and AFM probe 112. These transmission line segments 142 are designed to introduce reactance to counteract the impedance mismatch in the transmission line 140. By adjusting the length and position of each transmission line segment 142, the impedance of AFM probe 112 can be matched with that of the microwave signal generator and the semiconductor sample.

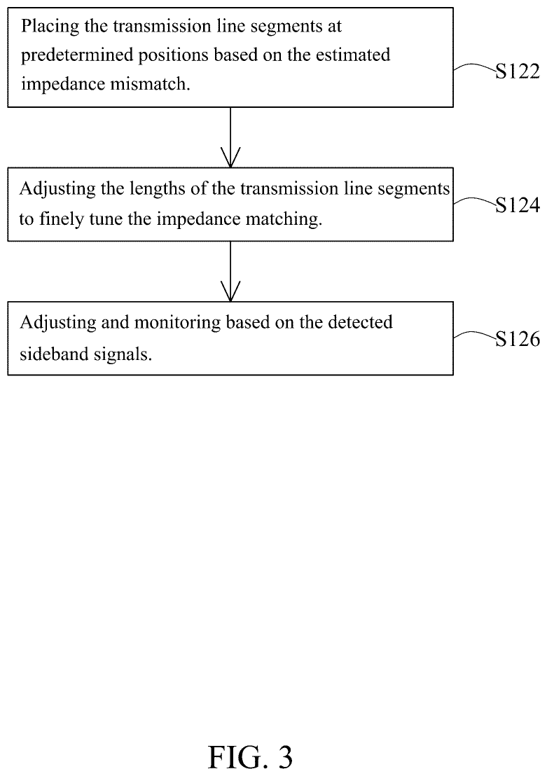

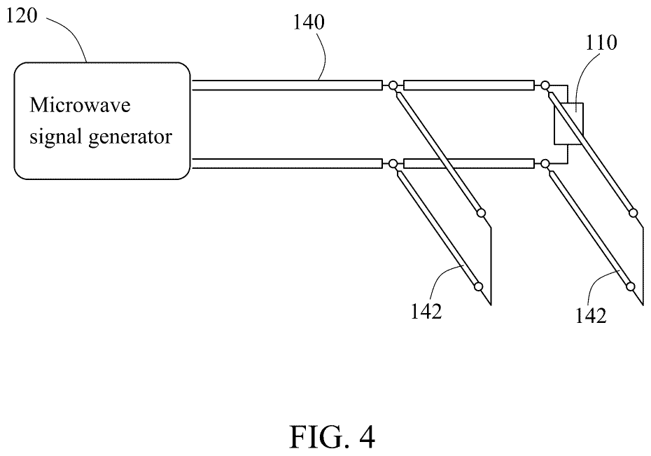

Referring to FIG. 2 and FIG. 3, FIG. 3 illustrates a flowchart of the double-stub impedance matching process set in this embodiment, and FIG. 4 illustrates a schematic diagram of performing double-stub impedance matching in this embodiment. Initially, as shown in step S122, based on the estimated impedance mismatch, the transmission line segments 142 are placed at predetermined positions on the transmission line 140. Next, as shown in step S124, the lengths of the transmission line segments 142 are adjusted to finely tune the impedance matching. The goal of this step is to eliminate microwave signal reflections at the AFM probe, ensuring maximum microwave energy transmission to the semiconductor sample. Subsequently, as shown in step S126, signal detection feedback is performed. The transmission line segments 142 are adjusted and monitored based on the detected sideband signals. As the transmission line segments 142 are adjusted, the strength and clarity of the sideband signals are measured to ensure that impedance matching is optimized.

By using double-stub impedance matching, this embodiment ensures that microwave signals are effectively transmitted through AFM probe 112 and into semiconductor sample 10, thereby making the measurement of electrical characteristics of semiconductor sample 10 more accurate and sensitive. Additionally, this technique helps identify the optimal carrier frequency for subsequent high-frequency measurements. In summary, performing double-stub impedance matching in this embodiment offers the following advantages:
1. Accuracy: Double-stub impedance matching provides two degrees of freedom (the length and position of each transmission line segment 142) for precise adjustment of impedance matching.
2. Flexibility: This method is suitable for systems with complex impedance mismatches that require fine-tuning within specific frequency ranges.
3. Improved Signal Transmission: By optimizing impedance matching, double-stub impedance matching significantly reduces signal reflections and losses, ensuring effective interaction between microwave signals and the semiconductor sample.

In addition to double-stub impedance matching, the present invention may consider using multi-stub impedance matching or single-stub impedance matching depending on different impedance matching scenarios. Multi-stub impedance matching involves using three or more transmission line segments 142 along transmission line 140, providing additional degrees of freedom for impedance adjustment.

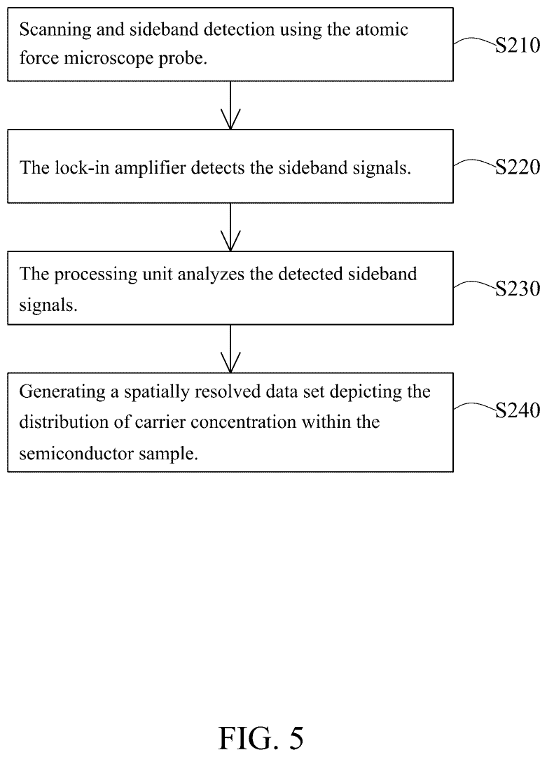

Referring to FIG. 2 and FIG. 5, FIG. 5 illustrates a flowchart of the process for generating a carrier distribution map. Initially, as shown in step S210, the AFM probe 112 performs scanning and sideband detection. AFM probe 112 scans the surface of semiconductor sample 10 in tapping mode, as described earlier. During the scanning process, the microwave signal emitted from AFM probe 112 interacts with the electrical properties of semiconductor sample 10, generating sideband signals. Next, as shown in step S220, the lock-in amplifier 130 detects the sideband signals at frequencies fd-fm and fd+fm, which encode information about the local carrier concentration and electrical environment of semiconductor sample 10. Then, as shown in step S230, the detected sideband signals are analyzed by the processing unit 150, which correlates the intensity and frequency characteristics of the sideband signals with the carrier concentration at various positions of semiconductor sample 10. The analysis process accounts for sideband signal variations caused by local impedance, material characteristics, and carrier mobility differences. By processing these signals across the entire scanned area, the AFM system 100 establishes a comprehensive data set reflecting the electrical characteristics of the semiconductor sample. As shown in step S240, once the sideband signals are processed, the AFM system 100 generates a spatially resolved data set depicting the distribution of carrier concentration within the semiconductor sample. These data sets form the basis for a carrier distribution map, illustrating the distribution of charge carriers within the material.

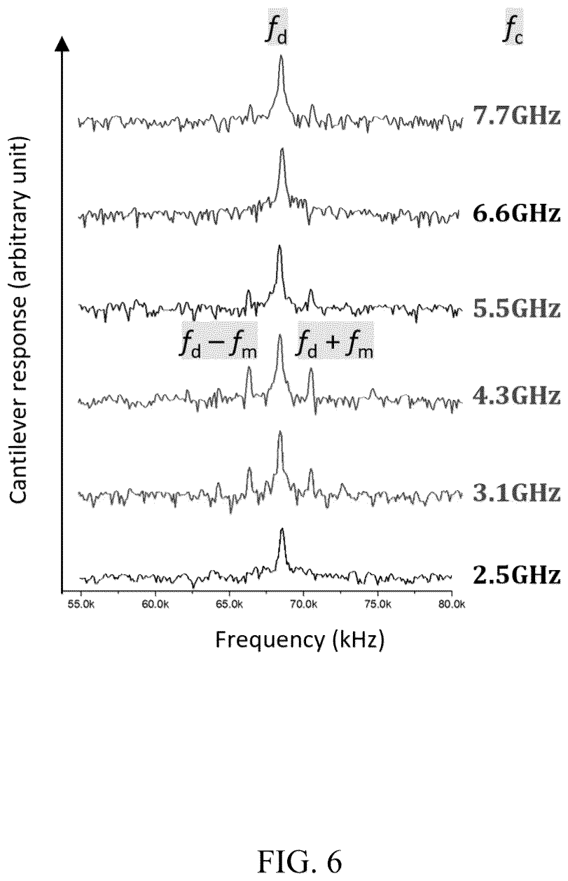

Next, referring to FIG. 2 and FIG. 6, FIG. 6 illustrates the experimental results obtained at various carrier frequencies. In this experiment, the microwave signal generator 120 emits a microwave signal with a carrier frequency fc ranging from 2 GHz to 7.7 GHZ. In the experimental setup, the atomic force microscope operates in tapping mode near the probe's resonance frequency fd, approximately 70 kHz; additionally, the modulation frequency fm is set to 2 kHz. Analysis of the detected sideband signals indicates that the optimal carrier frequencies fc for the semiconductor sample in this experiment are 4.3 GHZ and 3.1 GHz. At these carrier frequencies, the sideband signals (at frequencies fd-fm and fd+fm) are the strongest, indicating good impedance matching between the AFM probe and the semiconductor sample, and efficient transmission of the microwave signal. Subsequently, these optimal carrier frequencies can be used for further high-frequency measurements, such as Scanning Microwave Impedance Microscopy (sMIM).

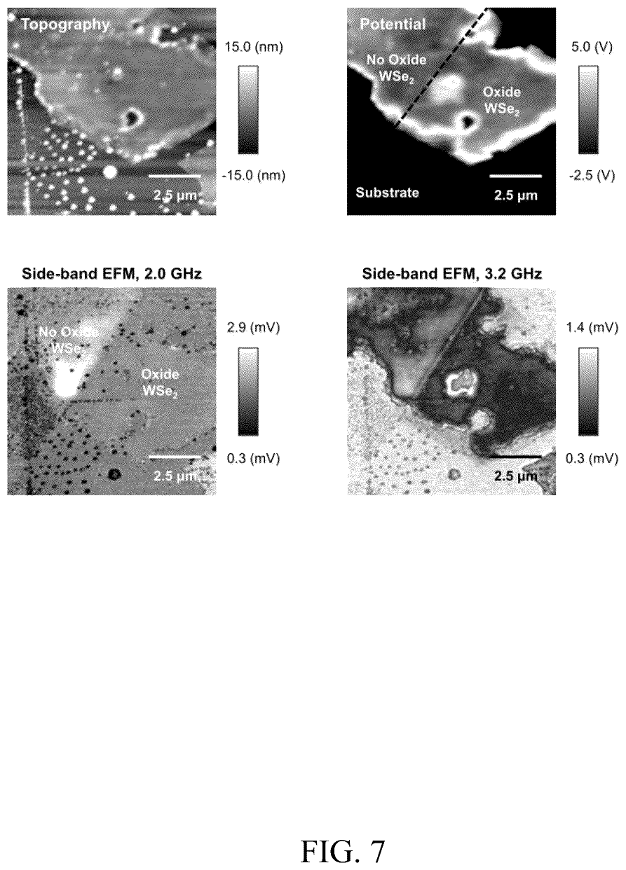

Referring to FIG. 7, FIG. 7 displays carrier distribution maps of a WSe₂ sample with mixed stacking sequences, including monolayer, bilayer, and multilayer structures. The figure provides detailed information on surface morphology, electrostatic potential, and differential carrier responses measured using Sideband Electrostatic Force Microscopy (Sideband-EFM) at different microwave excitation frequencies.

The upper left of FIG. 7 is a surface morphology image. The surface morphology of the WSe₂ sample shows the physical surface structure with height variations measured in nanometers (nm). The image distinguishes regions of different thicknesses, including monolayer and bilayer structures, as well as the overall surface morphology of the sample. White areas correspond to elevated features associated with thicker WSe₂ stacking sequences, while darker areas indicate thinner regions of the sample, such as monolayer structures.

The upper right of FIG. 7 is an electrostatic potential map. The potential map displays the variations in electrostatic potential across the surface of the WSe₂ sample. The map differentiates regions with and without oxide layers, labeled as “Non-Oxidized WSe₂” and “Oxidized WSe₂,” respectively. Areas with oxide layers exhibit higher potential values (shown as bright regions), whereas non-oxidized areas show lower potential values. The map also highlights the substrate, which displays significantly lower potential relative to the WSe₂ regions. This electrostatic mapping is crucial for identifying areas where the oxide layer affects the electrical behavior of the sample.

The lower left of FIG. 7 shows a carrier distribution map generated using Sideband-EFM under a 2.0 GHz microwave excitation. A clear differential carrier response is visible between oxidized and non-oxidized regions of the WSe₂ sample. The oxidized WSe₂ areas exhibit significantly higher signals, reaching up to 3.19 mV, while non-oxidized regions show lower values (approximately 0.02 mV). At 2.0 GHz, Sideband-EFM effectively distinguishes between oxidized and non-oxidized regions based on their different carrier responses, providing important insights into the electrical properties of these areas.

The lower right of FIG. 7 presents a carrier distribution map obtained using Sideband-EFM under a 3.2 GHz microwave excitation. At this higher frequency, the technique resolves differential carrier responses between different stacking structures (such as monolayer, bilayer, and multilayer) within the WSe₂ sample. The sensitivity of Sideband-EFM at this frequency allows for the detection of subtle differences in carrier responses, revealing the unique electrical properties of regions with different stacking sequences. In this image, carrier responses range from 0.02 mV to 1.69 mV.

The 3.2 GHz carrier distribution map is particularly useful for analyzing complex material structures, as traditional Scanning Capacitance Microscopy (SGM) can only resolve the bulk phase of WSe₂. Sideband-EFM is capable of resolving subtle differences in stacking sequences, making it a powerful tool for studying two-dimensional materials and other complex semiconductor structures.

The carrier distribution maps in FIG. 7 demonstrate the effectiveness of Sideband-EFM in resolving oxide layers and stacking sequences in WSe₂ samples at different microwave frequencies. The figure highlights the enhanced sensitivity of Sideband-EFM at 3.2 GHZ, enabling the differentiation of electrical characteristics in regions with different stacking sequences, including monolayer and bilayer structures. These insights are crucial for understanding the electrical behavior of two-dimensional materials and other semiconductor structures, providing valuable information for material research and device manufacturing. Additionally, as shown in FIG. 7, the optimal carrier frequencies identified using the methods of the present invention are not singular but may vary depending on different applications.

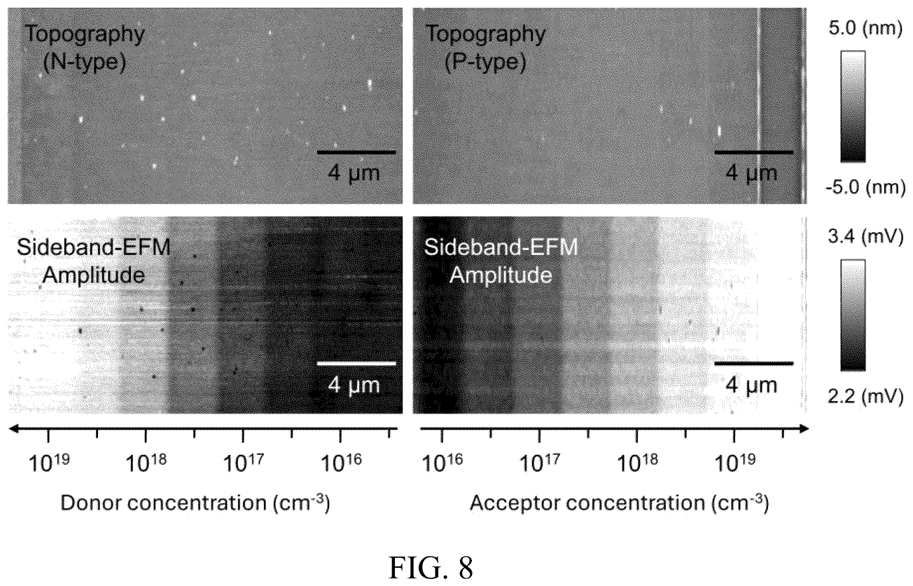

Referring to FIG. 8, FIG. 8 illustrates the high-resolution carrier concentration detection and differentiation of n-type and p-type semiconductors in standard concentration calibration samples using Sideband-EFM. FIG. 8 includes surface morphology images (top row) and Sideband-EFM amplitude maps (bottom row) corresponding to n-type and p-type samples, along with their respective donor and acceptor concentration ranges, from 10¹⁹ cm⁻³ to 10¹⁶ cm⁻³.

In the top row of the surface morphology images in FIG. 8, the surface images of n-type and p-type samples display the surface structures of each semiconductor region. These images are obtained based on a 4 μm scanning area, providing a fundamental understanding of the sample's surface morphology. The surface morphology of both n-type and p-type samples appears relatively smooth and uniform, with no significant height variations (ranging from −10.0 nm to 10.0 nm), indicating that different carrier concentration regions cannot be distinguished based solely on physical surface features.

The bottom row of FIG. 8 presents the Sideband-EFM amplitude maps. The amplitude maps for n-type and p-type samples highlight the significant advantages of using Sideband-EFM for carrier concentration detection. Compared to the surface images, the Sideband-EFM amplitude maps show clear differences in signal intensity across different regions of the samples. For the n-type sample (bottom left), as the donor concentration decreases from 10¹⁹ cm⁻³ to 10¹⁶ cm⁻³, the amplitude maps show a gradual weakening of the Sideband-EFM signals, with signal amplitudes ranging from 2.1 mV to 3.6 mV. Lower donor concentrations correspond to lower signal amplitudes (darker regions). For the p-type sample (bottom right), the Sideband-EFM amplitude maps similarly and clearly display differences between regions with varying acceptor concentrations. As the acceptor concentration decreases from 10¹⁹ cm⁻³ to 10¹⁶ cm⁻³, the signal amplitudes weaken, with higher acceptor concentrations corresponding to brighter regions in the amplitude maps.

FIG. 8 emphasizes the advantage of Sideband-EFM in providing highly sensitive, spatially resolved carrier concentration measurements in n-type and p-type semiconductor samples. The clear contrast in Sideband-EFM signals between different carrier concentration regions highlights the capability of this technique to detect subtle variations in donor and acceptor concentrations, which is crucial for evaluating the performance of semiconductor materials and devices. Compared to traditional techniques, which struggle to resolve these differences at lower carrier concentrations, Sideband-EFM offers high resolution across a concentration range from 10¹⁹ cm⁻³ to 10¹⁶ cm⁻³, making it an effective tool for characterizing semiconductor doping profiles.

In summary, the present invention offers multiple significant advantages in the detection and analysis of semiconductor carriers. These advantages make the semiconductor carrier detection methods of the present invention more practical, efficient, and accurate compared to existing technologies. The main advantages of the present invention are outlined below:

One primary advantage of the present invention is the reduction of costs associated with high-frequency atomic force microscopy measurements. Traditional methods typically require the use of complex and expensive waveguides to ensure effective transmission of microwave signals through the AFM cantilever. By optimizing the carrier frequency to directly transmit signals, the present invention eliminates the need for such waveguides, significantly reducing the overall cost and complexity of system setup. Moreover, the use of impedance matching techniques, such as double-stub and multi-stub impedance matching, ensures maximal signal transmission without the need for costly hardware modifications. This streamlined approach lowers operational costs and makes the system more suitable for semiconductor research and manufacturing applications.

Additionally, the present invention provides significant improvements in the accuracy and sensitivity of semiconductor carrier detection. By determining the optimal carrier frequency through sideband analysis, the system ensures that microwave signals are effectively transmitted through the AFM probe to the semiconductor sample. This optimal frequency selection minimizes signal reflections and losses, resulting in high-quality data and reduced noise interference. The use of impedance matching techniques (such as double-stub impedance matching) further enhances the system's accuracy by ensuring that microwave signals are transmitted in the most efficient manner. These techniques reduce the impact of impedance mismatches, thereby preventing measurement distortions and allowing for more precise analysis of carrier concentration and distribution.

Furthermore, the method can be applied to various high-frequency measurement techniques, such as Scanning Microwave Impedance Microscopy and Sideband Electrostatic Force Microscopy, enabling adaptability to a wide range of research and industrial applications. The system is capable of accurately measuring carrier concentration and distribution, which is crucial for the stringent quality control and precision required in semiconductor manufacturing.

Although the invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

1. A method for detecting semiconductor carriers, comprising:
operating an atomic force microscope (AFM) in a tapping mode, and oscillating a cantilever of the AFM at a resonance frequency fd;
emitting a microwave signal at a carrier frequency fc from a probe of the AFM using a microwave signal generator;
amplitude modulating the microwave signal at a modulation frequency fmf_mfm;
scanning a semiconductor sample with the AFM probe while emitting and modulating the microwave signal;
detecting sideband signals at frequencies fd-fm and fd+fm using a lock-in amplifier;
analyzing the detected sideband signals to determine an optimal carrier frequency for subsequent high-frequency measurements, and utilizing the optimal carrier frequency to evaluate carrier concentration and distribution within the semiconductor sample.

2. The method of claim 1, further comprising using the determined optimal carrier frequency to perform subsequent measurements on the semiconductor sample, wherein the measurements are conducted using a Scanning Microwave Impedance Microscope or a Sideband Electrostatic Force Microscope.

3. The method of claim 2, wherein the measurements are conducted using a Scanning Microwave Impedance Microscope or a Sideband Electrostatic Force Microscope.

4. The method of claim 1, wherein the carrier frequency fc is within a range of 2 GHz to 7.7 GHZ.

5. The method of claim 1, wherein the modulation frequency fmf_mfm is within a range of 1 kHz to 10 kHz.

6. The method of claim 1, wherein the resonance frequency fd is approximately 70 kHz.

7. The method of claim 1, further comprising optimizing impedance matching between the microwave signal generator and the AFM probe using a double-stub impedance matching technique, thereby enhancing the transmission efficiency of the microwave signal into the semiconductor sample.

8. The method of claim 7, wherein the double-stub impedance matching is adjusted to maximize the amplitude of the detected sideband signals, thereby enhancing the accuracy of determining the optimal carrier frequency.

9. The method of claim 1, wherein the semiconductor sample is a doped semiconductor, and the carrier concentration of the doped semiconductor is in a range of 10¹⁶ to 10²⁰ carriers per cubic centimeter.

10. The method of claim 1, further comprising calibrating the method by using a standard semiconductor sample with a known carrier concentration prior to scanning the semiconductor sample.
